(19) United States
(12) Patent Application Publication
(10) Pub. No.: US 2008/0188627 A1
(43) Pub. Date: Aug. 7, 2008

(54) METHOD FOR MAKING CHLORINATED POLYOLEFIN SOLUTIONS AND COATINGS

(75) Inventors: Gregory G. Menovcik, Northville, MI (US); William H. Merritt, Ferndale, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/671,006

(22) Filed: Feb. 5, 2007

(51) Int. Cl. C08L 65/00; C08F 110/00

(52) U.S. Cl. 525/416; 526/348

(57) ABSTRACT

A method of making an organic solution of a chlorinated polyolefin that produces a storage-stable solution, a chlorinated polyolefin resin is dissolved in a hydrocarbon solvent that is predominantly aliphatic hydrocarbon, aromatic hydrocarbons other than toluene and xylene, or mixtures of these, held at a temperature from 118 to 125° C., for an adequate time for complete dissolution, then cooled and a cosolvent is added at a temperature below the boiling point of the cosolvent but at a temperature at which the chlorinated polyolefin solution is still clear or has little haziness. The solution can be used to prepare coatings, primers, inks, and adhesives, particularly for plastic substrates such as thermoplastic polyolefin.

### FIELD

The present disclosure concerns methods for making chlorinated polyolefin solutions in organic solvents and coatings, primers, inks, and adhesives containing such solutions.

### BACKGROUND

This section provides background information related to the present disclosure that may or may not describe prior art.

It is often desirable, for decorative or functional reasons, to apply a coating over a plastic substrate. It has been difficult to find coating compositions for certain substrates that provide the required adhesion at a reasonable price and with suitable physical properties. It is well-known that it is difficult to obtain good adhesion of paints to olefinic substrates, including thermoplastic polyolefin (TPO) substrates and other such polyolefin-based materials.

Weakly chlorinated polyolefins have been used as binder resins for coatings, primers, and adhesives with excellent adhesion to polyolefin substrates. One problem that arises in organic solvent-based chlorinated polyolefin compositions is thickening or gelation during storage. Kashihara et al., U.S. Pat. No. 7,019,080 discusses that, on the one hand, it is desirable to keep the chlorine content of the chlorinated polyolefin as low as possible to attain the best solvent resistance and adhesion to polyolefins but, on the other hand, low chlorine content leads to thickening and gelation during storage. The Kashihara et al., '080 patent proposes improving storage stability by preparing the chlorinated polyolefin with chlorine content of 10-40 wt. % from an isotactic polypropylene polymer with a molecular weight distribution of 3 or less and a melting point of 110-140° C.

Tsuneka et al., U.S. Pat. No. 5,821,301 discloses preparing a primer containing a chlorinated polyolefin with acid value of 1-500 mg KOH/g having one epoxy group per molecule to prevent formation of particles in the primer during storage. Higher epoxy values result in increased viscosity. Asato et al., U.S. Pat. No. 5,030,681 discloses that crystallization of acid-modified, chlorinated polyolefin paints can be overcome by esterifying unreacted unsaturated carboxylic acid or anhydride remaining from grafting such acid or anhydride onto the chlorinated polyolefin.

Solutions of chlorinated polyolefin resins in aromatic hydrocarbons, particularly toluene and xylene, have exhibited good storage stability. Toluene and xylene, however, have been designated by the US Environmental Protection Agency to be hazardous air pollutants (HAPs). Urata et al., U.S. Patent Application Publication US 2003/010348 disclose improved viscosity stability for a solution of 10-40 wt. % carboxylated chlorinated polyolefin resin (chlorine content of 12-26 wt. %) in a mixed solvent of an alicyclic hydrocarbon and a polar solvent, optionally also with an aromatic hydrocarbon. The mixed solvent is 90-100% alicyclic hydrocarbons of 5-9 carbon atoms and the polar solvent, the hydrocarbon and polar solvents being in a weight ratio of 80/20 to 40/60. The polar solvents are alcohols, esters, ketones, and ethers, preferably with at least 4 carbon atoms. The resin is apparently dissolved in the solvent mixture at room temperature. An earlier Japanese patent to Mr. Urata and coinventors, JP 06-306227, published Nov. 1, 1994, proposed a mixed solvent of alicyclic hydrocarbon and aromatic hydrocarbon for a 15-40 wt. % solution of chlorinated polyolefin having 12-26 wt % chlorine content.

Manufacturers of chlorinated polyolefin resins have recommended preparing solutions at fairly low temperatures, optimally 60° C. The stabilities of solutions made in weaker aliphatic and aromatic hydrocarbon solvents, which are desirable from the standpoint of not being regulated as HAPs materials, however, have been poor; moreover, the viscosities of such solutions are high, requiring a greater amount of solvent to make a composition with desirable application properties. Hence, the present inventors sought an alternative method of stabilizing an organic solution of chlorinated polyolefin.

### SUMMARY

We disclose a method of making an organic solution of a chlorinated polyolefin that produces a storage-stable solution, the solution prepared by our method, and compositions made with the solution of our method. In our method, a chlorinated polyolefin resin is dissolved in a hydrocarbon solvent that is predominantly aliphatic hydrocarbon, aromatic hydrocarbons other than toluene and xylene, or mixtures of these at a temperature of from 118 to 125° C., particularly at 120 to 122° C., held at the temperature for an adequate time for complete dissolution, particularly for at least about ninety minutes, then cooled and a cosolvent is added at a temperature below the boiling point of the cosolvent but at a temperature at which the chlorinated polyolefin solution is still clear or has little haziness, particularly at about 50 to 75° C. The solution may then be cooled, if needed, to a storage or use temperature. The solution has from about 60 to about 90 percent by weight of the mixture of the hydrocarbon solvent and cosolvent and from about 10 to about 40 percent by weight of chlorinated polyolefin resin. The solution has 0.1 to 10 wt. % of the cosolvent. It may be preferred that the mixture has 5 wt. % or less total amount of xylene and toluene for compliance with HAPs regulations.

The solution produced by this process has a lower viscosity than one prepared at room temperature or at suggested manufacturers' temperatures of 60° C. and has very good storage stability at room temperature, in the freezer (minus 20° F.), and in the hot box (140° F.). The method produces chlorinated polyolefin solutions that exhibit excellent application properties when incorporated into coatings, primers, and adhesives, excellent low temperature fluidity and workability, and stability with little or no solvents that are regulated at HAPs. In particular, the solution is resistant to gelling, which improves adhesion of compositions made with the chlorinated polyolefin solution.

Also provided are coatings, primers, inks, and adhesives containing the chlorinated polyolefin solutions made by our process. Because the solutions are lower in viscosity, it is possible to prepare coatings, primers, inks, and adhesives containing the solutions with less additional organic solvent than would otherwise be needed for application viscosities. The compositions are particularly useful for plastic substrates such as thermoplastic polyolefin.

Further areas of applicability will become apparent from the description provided herein. It should be understood that the description and specific examples are intended for purposes of illustration only and are not intended to limit the scope of the present disclosure.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all values and further divided ranges within the entire range.

### DETAILED DESCRIPTION

Further areas of applicability and advantages will become apparent from the following description. It should be understood that the description and specific examples, while exemplifying various embodiments of the invention, are intended for purposes of illustration and are not intended to limit the scope of the invention.

A chlorinated polyolefin resin is dissolved in a hydrocarbon solvent that is predominantly aliphatic hydrocarbon, aromatic hydrocarbons other than toluene and xylene, or mixtures of these at a temperature of from 118 to 125° C., particularly at 120 to 122° C. The hydrocarbon solvent preferably includes at least about 40 wt. %, more preferably at least about 45 wt. % and still more preferably at least about 50 wt. % aliphatic hydrocarbon, which may be selected from linear aliphatic hydrocarbons, branched aliphatic hydrocarbons, cycloaliphatic hydrocarbons, and combinations of these. The solvent mixture may include up to about 100 wt. %, preferably up to about 80 wt. %, and more preferably up to about 60 wt. % of the aliphatic hydrocarbons. In a preferred method, the solvent mixture contains from about 50 to about 60 weight percent of the aliphatic hydrocarbons.

Suitable examples of linear aliphatic hydrocarbons, branched aliphatic hydrocarbons, cycloaliphatic hydrocarbons include, without limitation, n-pentane, hexane, heptane, octane, cyclopentane, cyclohexane, methylcyclopentane, and mixtures such as solvent naphtha and branched paraffinic solvent blends such those sold under the ISOPAR brand name by ExxonMobil. In a preferred embodiment, solvent naphtha is used as the aliphatic hydrocarbon. The solvent naphtha is preferably a light aromatic grade such as CAS #64742-95-6.

The solvent mixture may also include aromatic hydrocarbon solvent. Nonlimiting examples of suitable aromatic hydrocarbons that may be used include toluene, xylene, ethyl benzene, trimethyl benzene (e.g., 1,2,4-trimethylene benzene, 1,3,5-trimethylbenzene), cumene, and combinations thereof. In preferred embodiments, the combined amount of toluene and xylene included in the solvent mixture is not more than 5 wt. %, and in other preferred embodiments the combined amount of toluene and xylene included in the solvent mixture is not more than 1 wt. %. The solvent mixture preferably includes at least about 25 wt. %, more preferably at least about 30 wt. % and still more preferably at least about 35 wt. % of the aromatic hydrocarbon. The solvent mixture may include up to about 50 wt. %, preferably up to about 45 wt. %, and more preferably up to about 40 wt. % of the aromatic hydrocarbon. In a preferred method, the solvent mixture contains from about 30 to about 40 weight percent aromatic hydrocarbon. In certain preferred embodiments, the solvent mixture includes from about 30 to about 40 weight percent of trimethylbenzene.

Mixtures comprising solvent naphtha and aromatic hydrocarbons with range of fractional distillation of 90 to 220° C. obtained by fractionally distilling coal tar-based light oil and petroleum-based light oil are commercially available and can be used. Suitable examples are Solvesso 100 (from ExxonMobil Corp.), Aromatic 100 (from ExxonMobil Corp.), which have high boiling point solvents with range of fractional distillation of 160 to 180° C., and Solvesso 150 and Aromatic 150, which have boiling point solvents with range of fractional distillation of 180 to 220° C.

Examples of the useful chlorinated polyolefins include chlorinated polyolefins prepared by chlorinating isotactic polypropylene polymers; carboxyl-containing chlorinated polyolefins prepared by graft-polymerizing unsaturated carboxylic acid monomers with chlorinated polyolefins prepared by chlorinating isotactic polypropylene polymers; carboxyl-containing chlorinated polyolefins prepared by graft-polymerizing unsaturated carboxylic acid monomers with isotactic polypropylene polymers to give carboxyl-containing polyolefins and chlorinating the carboxyl-containing polyolefins. Examples of isotactic polypropylene polymers used as starting materials include isotactic propylene-α-olefin random copolymers, isotactic polypropylenes, and the like. Preferable are isotactic propylene-α-olefin random copolymers. The chlorination of polyolefin or carboxyl group-containing polyolefin can be carried out easily by usual reaction methods. For example, the reaction may be conducted by dispersing or dissolving polyolefin or carboxyl group-containing polyolefin into a medium such as water, carbon tetrachloride or chloroform, and by blowing-in chlorine gas at a temperature in the range from 50 to 120° C. under applied pressure or ambient pressure in the presence of catalyst or under irradiation of ultraviolet rays.

Some examples of chlorinated polyolefins can be found in U.S. Pat. Nos. 4,683,264; 5,102,944; 5,319,032; and 7,019,080. Chlorinated polyolefins are known in the art and are commercially available form various companies, including Nippon Paper, Tokyo, Japan, under the designation Superchlon; Eastman Chemical Company, Kingsport, Tenn. under the designation CPO; and Toyo Kasei Kogyo Company, Ltd., Osaka, Japan under the designation Hardlen. The chlorinated polyolefin resin that is dissolved in the solvent mixture may also be a carboxyl or anhydride group-containing chlorinated polyolefin. The chlorine content of the carboxyl group-containing chlorinated polyolefin differs depending on the type of raw material polyolefin before chlorination. Chlorinated polyolefins typically have a chlorine content of at least about 10%, preferably at least about 15% by weight and up to about 40%, preferably up to about 30% by weight, but a range of 12 to 26% by weight is preferred.

The chlorinated polyolefin may be prepared from crystalline polypropylene that is isotactic polypropylene, and one with weight average molecular weight of 10,000 to 300,000 can be used. The chlorinated polyolefin in general may have number average molecular weight of from about 2000 to about 150,000, preferably from about 50,000 to about 90,000. Chlorinated polyolefins having number average molecular weights of from about 65,000 to about 80,000 are particularly preferred.

Propylene-α-olefin copolymer used as the raw material is mainly composed of propylene copolymerized with a-olefin, and either block copolymer or random copolymer can be used. As the α-olefin components, for example, ethylene, 1-butene, 1-pentene, 1-hexene, 1-heptene, 1-octene, 1-decene, 1-dodecene, 1-hexadecene, 4-methyl-1-pentene, and so on are suitable. The content of propylene component is optimally 50 to 99 mol % and, if under 50 mol %, the adherence to polyolefin may decrease in some embodiments. Also, if over 99 mol %, the flexibility of the coated film may decrease.

Examples of methods for polymerizing isotactic polypropylene polymers include suspension polymerization conducted in the presence of a hydrocarbon solvent or propylene solvent, gas-phase polymerization, and similar methods. Isotactic polypropylene polymers are preferably produced in the presence of a metallocene catalyst.

Graft-polymerizing an unsaturated carboxylic acid monomer with an isotactic polypropylene polymer can be conducted according to known methods, e.g., a polyolefin is brought to reaction by heating it in the presence of a radical generator to a temperature above its melting point and fusing it (fusion method), or by dissolving a polyolefin in an organic solvent and heating and stirring it in the presence of a radical generator (solution method). Examples of unsaturated carboxylic acid monomers usable in the reaction include maleic acid, maleic anhydride, fumaric acid, citraconic acid, citraconic anhydride, mesaconic acid, itaconic acid, itaconic anhydride, aconitic acid, aconitic anhydride, himic anhydride, and so on, which may be used in combination. Generally, 1-10 wt. % of the acid monomer may be incorporated.

A carboxyl-containing terpolymer may be copolymerized from unsaturated carboxylic acid monomer, unsaturated vinyl ester monomer, and ethylene through known processes such as high-pressure radical polymerization, solution polymerization, and emulsion polymerization. As the unsaturated carboxylic acid monomer components, nonlimiting examples include acrylic acid, methacrylic acid, maleic acid, itaconic acid, fumaric acid, maleic anhydride, and itaconic anhydride. As the unsaturated vinyl ester monomers, nonlimiting examples include methyl acrylate, ethyl acrylate, butyl acrylate, methyl methacrylate, ethyl methacrylate, and butyl methacrylate. The content of unsaturated carboxylic acid monomer is preferably 1 to 10% by weight. If under 1% by weight, then adhesion may be poor because of too low content of polar groups in the composition, and more than 10% by weight may cause gelation during chlorination. The content of unsaturated vinyl ester monomer is preferably 1 to 50% by weight. If under 1% by weight, then adhesion may not be as great, and, if exceeding 50% by weight, advantages such as processing improvements, flexibility and mechanical strength that the ethylene polymer possesses are lost.

The chlorinated polyolefin resin is dissolved in the hydrocarbon solvent that is predominantly aliphatic hydrocarbon, aromatic hydrocarbons other than toluene and xylene, or mixtures of these at a temperature of from 118 to 125° C., particularly at 120 to 122° C. The mixture of chlorinated polyolefin and hydrocarbon solvent is held at the temperature for an adequate time for complete dissolution. Preferably, the mixture of chlorinated polyolefin and hydrocarbon solvent is held at the temperature for at least about ninety minutes, and in some embodiments it may be preferable to hold the mixture at the dissolution temperature for two hours or more. Once a good solution is established, the solution of chlorinated polyolefin and hydrocarbon solvent is cooled and a polar, cosolvent is added at a temperature below the boiling point of the polar solvent but at a temperature at which the chlorinated polyolefin resin is still clear or has little haziness, particularly at about 50 to 75° C. The solution may then be cooled, if needed, to a storage or use temperature.

The chlorinated polyolefin solution includes 0.1 to 10 wt. % of cosolvent. In certain embodiments, the chlorinated polyolefin solution includes 0.5 to 5 wt. % of cosolvent, preferably 1-3 wt. % of cosolvent. A cosolvent for our process is a solvent that is soluble or miscible in water and has at least 4 carbon atoms. The cosolvent has at least one polar group selected from hydroxyl groups, ether groups, and amide groups. Nonlimiting examples of useful cosolvents are glycol ethers and amides. Particular compounds that may be used include, without limitation, 1-methyl-2-pyrrolidoinone, ethylene glycol monomethyl ether, ethylene glycol monoethyl ether (2-ethoxy ethanol), ethylene glycol monopropyl ether, ethylene glycol monobutyl ether (2-butoxy ethanol), ethylene glycol monoisobutyl ether, ethylene glycol mono-tert-butyl ether, ethylene glycol monoisopropyl ether, ethylene glycol monohexyl ether, 1,3-butyleneglycol-3-monomethyl ether, diethylene glycol monomethyl ether, diethylene glycol monoethyl ether, diethylene glycol monobutyl ether, propylene glycol monomethyl ether, dipropylene glycol monomethyl ether, propylene glycol n-butyl ether, propylene glycol n-propyl ether, and dipropylene glycol n-butyl ether, which may be used singly or in any combination of two or more.

The chlorinated polyolefin is preferably 10 to 40% by weight of the solution in hydrocarbon solvent and cosolvent. In some embodiments, the chlorinated polyolefin is preferably 15 to 20% by weight of the solution in hydrocarbon solvent and cosolvent. The solution has a surprisingly low viscosity at a given solids content, requiring less additional solvent in preparing application compositions, which in turn reduces volatile organic content of the finished products.

The chlorinated polyolefin solution can be used as in preparing coatings, inks, adhesives, and so on, particularly for use with polyolefin substrates such as polyolefin films, sheets, and moldings. A primer including the polyolefin solution for painting polyolefin-based automotive parts, such as bumpers provides a coating that adheres well to the surface of substrate without washing with trichloroethane vapor, flame or corona treatment, or any other pre-treatment beyond normal part washing.

Coating compositions prepared using the chlorinated polyolefin solution may include further binder materials, pigments, solvents, and additives.

Nonlimiting examples of further binder materials that may be included in compositions of the invention include acrylic resins, vinyl resins, alkyd resins, polyesters, polyurethanes, polyethers, and epoxy resins. Also included are polymers in which one kind of polymer is used as a monomer in forming another, such as a polyester-polyurethane, acrylic-polyurethane, or a polyether-polyurethane in which a dihydroxy functional polyester, acrylic polymer, or polyether is used as a monomer in the urethane polymerization reaction. The compositions may include an olefin-based block copolymer that has an olefin block and at least one (poly)ester or (poly)ether block as described in McGee et al., U.S. Pat. Nos. 6,300414, 6,423,778, and 6,841,619 and in U.S. Patent Application Publication 2005/0131151, each of which is incorporated herein by reference. The olefin-base block copolymer with (poly)ester or (poly)ether block may be included in the composition in an amount between about 0.01 and about 30% by weight based on total binder weight. Binder is used to mean the resin and polymer components of a composition. The binder components may have functional groups, for example, without limitation, hydroxyl, carboxyl, carbamate, urea, epoxide (oxirane), primary or secondary amine, amido, thiol, silane, and so on and combinations of these, in which case the composition may further include a curing agent or crosslinker that is reactive with such functional groups under selected curing conditions. The curing agent has, on average, at least about two crosslinking functional groups. Suitable curing agents include, without limitation, materials having active methylol or methylalkoxy groups, such as aminoplast crosslinking agents or phenol/formaldehyde adducts, curing agents that have isocyanate groups, particularly blocked isocyanate curing agents; curing agents having epoxide groups; and combinations of these. Examples of specific curing agent compounds include melamine formaldehyde resins (including monomeric or polymeric melamine resin and partially or fully alkylated melamine resin), blocked or unblocked polyisocyanates (e.g., toluene diisocyanate, MDI, isophorone diisocyanate, hexamethylene diisocyanate, and isocyanurate trimers of these, which may be blocked for example with alcohols or oximes), urea resins (e.g., methylol ureas such as urea formaldehyde resin, alkoxy ureas such as butylated urea formaldehyde resin), polyanhydrides (e.g., polysuccinic anhydride), polysiloxanes (e.g., trimethoxy siloxane), and combinations of these. Unblocked polyisocyanate curing agents are usually formulated in two-package (2K) compositions, in which the curing agent and the film-forming polymer (in this case, at least the block copolymer) are mixed only shortly before application and because the mixture has a relatively short pot life. The curing agent may be combinations of these, particularly combinations that include aminoplast crosslinking agents. Aminoplast resins include melamine formaldehyde resins or urea formaldehyde resins.

The composition containing the chlorinated polyolefin solution may include other materials, such as, without limitation, catalysts suitable for reaction of the particular crosslinker, other organic solvents, surfactants, stabilizers, matting agents, wetting agents, rheology control agents, dispersing agents, pigments, fillers, UV absorbers, hindered amine light stabilizers, antioxidants, silicone additives, other customary coatings additives, and combinations of these. Suitable pigments and fillers include, without limitation, conductive pigments, including conductive carbon black pigments and conductive titanium dioxide pigments; non-conductive titanium dioxide and carbon pigments, graphite, magnesium silicate, ferric oxide, aluminum silicate, barium sulfate, aluminum phosphomolybdate, aluminum pigments, and color pigments. The pigments and, optionally, fillers are typically included at a pigment to binder ratio of from about 0.1 to about 0.6, preferably from about 0.1 to about 0.25.

The compositions of the invention can be applied to a desired substrate, such as to a thermoplastic polyolefin substrate, by suitable means, including spray coating, dip coating, roll coating, curtain coating, brushing, and knife coating. The applied composition can be cured and/or dried. If desired, a coating composition can be applied over the composition of the invention, either before (“wet on wet”) or after curing of the composition of the invention. Compositions of the invention may be applied at thicknesses that will produce dry film or cured film thicknesses typical of the art, such as from about 0.01 to about 5.0 mils. Typical thicknesses for adhesion promoter layers are from about 0.1 to about 0.5 mils, preferably from about 0.2 to about 0.3 mils. Typical thicknesses for primer layers are from about 0.5 to about 2.0 mils, preferably from about 0.7 to about 1.5 mils.

After application to the substrate, the compositions of the invention may be heated to facilitate interaction with the substrate and thus to develop the adhesion of the applied composition to the substrate. Preferably, the coated substrate is heated to at least about the softening temperature of the plastic substrate. The adhesion promoters and coating compositions are preferably thermally cured. Curing temperatures will vary depending on the particular blocking groups used in the crosslinking agents, however they generally range between 160 and 270° F. The curing temperature profile must be controlled to prevent warping or deformation of the TPO substrate or other plastic substrate. In a one embodiment, the cure temperature is preferably between 225° F. and 270° F., and in another embodiment at temperatures no higher than about 265° F. The curing time will vary depending on the particular components used, and physical parameters such as the thickness of the layers, however, typical curing times range from 15 to 60 minutes, and preferably 20-35 minutes. The curing conditions depend upon the specific coating composition and substrate, and can be discovered by straightforward testing.

The coating compositions of the invention are particularly suited to coating olefinic substrates, including, without limitation, TPO substrates, polyethylene substrates, and polypropylene substrates. The coating compositions may also be used, however, to coat other thermoplastic and thermoset substrates, including, without limitation, polycarbonate, polyurethane, and flexible substrates like EPDM rubber or thermoplastic elastomers. Such substrates can be formed by any of the processes known in the art, for example, without limitation, injection molding and reaction injection molding, compression molding, extrusion, and thermoforming techniques.

The materials and processes of the invention can be used to form a wide variety of coated articles, including, without limitation, appliance parts, exterior automotive parts and trim pieces, and interior automotive parts and trim pieces.

The invention is further described in the following example. The example is merely illustrative and does not in any way limit the scope of the invention as described and claimed. All parts are parts by weight unless otherwise noted.

### EXAMPLES

### Example 1 of the Invention

Aromatic 100, 83 parts by weight, and chlorinated polyolefin pellets, 15 parts by weight, are charged to a clean vessel equipped with heating and stirring. The contents of the vessel are heated to 121° C. and held at that temperature, with continued stirring, for two hours. The temperature of the resulting solution is then reduced to 60° C., and 2 parts by weight of ethylene glycol monobutyl ether is added. The solution is cooled to room temperature.

### Example A, Comparative Example

Aromatic 100, 85 parts by weight, and chlorinated polyolefin pellets, 15 parts by weight, are charged to a clean vessel equipped with heating and stirring. The contents of the vessel are heated to 60° C. and held at that temperature, with continued stirring, for two hours. The solution is cooled to room temperature.

### Viscosity Testing

The viscosity of Example 1 of the invention and Comparative Example A were measure at 25° C. with a Brookfield VAP-1000+ viscometer. Example 1 of the invention and Comparative Example A were kept at room temperature, and their viscosities were measured again after one day, three days, three weeks, four weeks, and 7 weeks. The results are shown in the following table.

Viscosity, in centipoise

| | Example 1 | Comparative Example A |
|---|---|---|
| Initial | 23 | 29 |
| 1 Day | 23 (no increase) | 29 (no increase) |
| 3 Days | 23 (no increase) | 32 (10% increase) |
| 3 Weeks | 27 (13% increase) | 41 (41% increase) |
| 4 Weeks | 29 (26% increase) | 46 (59% increase) |
| 7 Weeks | 30 (30% increase) | 60 (141% increase) |

### Example 2 of the Invention

A coating composition is prepared by combining 7 parts by weight of the solution of Example 1, 16 parts by weight of an olefin block copolymer with acid-functional (poly)ester end blocks, 15 parts by weight of a hydroxyl-functional acrylic polymer, (50 wt. % nonvolatile in a mixture of aromatic and aliphatic hydrocarbons), 9 parts by weight of pigments (carbon black, titanium dioxide, fumed silica), 7 parts by weight hydroxyl-functional polyester polymer, (100 wt. % nonvolatile), 2 parts by weight of an alkylated melamine-formaldehyde resin, less than 1 part by weight of a blocked para-toluene sulfonic acid catalyst, 29 parts by weight of a mixture of aromatic and aliphatic hydrocarbons, and 14 parts by weight of ketones.

The coating is applied to a plastic substrate by spray application and thermoset to a 0.3 mil filmbuild. The coating has excellent adhesion to the plastic substrate.

The invention has been described in detail with reference to preferred embodiments thereof. It should be understood, however, that variations and modifications can be made within the spirit and scope of the invention and of the following claims.

What is claimed is:

1. A method of making an organic solution of a chlorinated polyolefin, comprising:
dissolving a chlorinated polyolefin in a hydrocarbon solvent at a first temperature of from 118 to 125° C.,
cooling the solution of chlorinated polyolefin in hydrocarbon solvent to a second temperature and adding a cosolvent, wherein the second temperature is below the boiling point of the cosolvent and a temperature at which the chlorinated polyolefin remains in solution.

2. A method according to claim 1, wherein the second temperature is from about 50 to 75° C.

3. A method according to claim 1, wherein the chlorinated polyolefin and the hydrocarbon solvent are mixed together at a temperature of from 118 to 125° C. for at least about ninety minutes.

4. A method according to claim 1, wherein the chlorinated polyolefin and the hydrocarbon solvent are mixed together at a temperature of from 118 to 125° C. for at least about two hours.

5. A method according to claim 1, wherein the first temperature is from 120 to 122° C.

6. A method according to claim 1, wherein the solution produced by the method has from about 10 to about 40 weight percent of the chlorinated polyolefin.

7. A method according to claim 1, wherein the solution produced by the method has from about 0.1 to about 10 weight percent of the cosolvent.

8. A method according to claim 1, wherein the solution produced by the method has 5 weight percent or less of combined weight of xylene and toluene.

9. A method according to claim 1, wherein the hydrocarbon solvent has at least about 40 weight percent of aliphatic hydrocarbon.

10. A method according to claim 1, wherein the hydrocarbon solvent comprises solvent naphtha.

11. A method according to claim 1, wherein the hydrocarbon solvent has about 30 to about 40 weight percent of trimethylbenzene.

12. A method according to claim 1, wherein the cosolvent is a member selected from the group consisting of amides and glycol ethers.

13. A method according to claim 1, wherein the cosolvent is a member selected from the group consisting of glycol ethers.

14. A composition comprising an organic solution of a chlorinated polyolefin prepared according to claim 1.

15. A composition according to claim 14, wherein the composition is selected from the group consisting of coatings, primers, inks, and adhesives.
